(19) United States
(12) Patent Application Publication
(10) Pub. No.: US 2024/0316461 A1
(43) Pub. Date: Sep. 26, 2024

(54) USING LASER TO ALIGN A VIRTUAL ENVIRONMENT IN A GAME ENGINE

(71) Applicant: Sony Interactive Entertainment LLC, San Mateo, CA (US)

(72) Inventor: Derek Crosby, Los Angeles, CA (US)

(21) Appl. No.: 18/189,886

(22) Filed: Mar. 24, 2023

(51) Int. Cl. A63F 13/65; G01B 11/00

(52) U.S. Cl. CPC A63F 13/65; G01B 11/002; A63F 2300/69

(57) ABSTRACT

A laser emitting visible light is used to project geometric shapes onto the floor of a stage or set at locations corresponding to locations of virtual objects in a computer simulation. The stage or set may be a motion capture (MoCap) set with IR reflectors on the set and actors. The visible laser light does not interfere with the MoCap and allows a real world actor to visually understand where objects in a computer simulation are emulated to be.

### FIELD

The application relates generally to technically inventive, non-routine solutions that are necessarily rooted in computer technology and that produce concrete technical improvements. In particular, the present application relates to techniques for using lasers to align a virtual environment in a game engine.

### BACKGROUND

Owing to health and cost concerns, people increasingly collaborate together from remote locations. As understood herein, collaborative movie and computer simulation (e.g., computer game) generation using remote actors can pose unique coordination problems in that actors may have difficulty visualizing where virtual objects are emulated to be in the real world relative to the sound stage or set. Furthermore, for computer simulation-related activities such as motion capture (MoCap), it is important that MoCap markers remain visible to the camera to capture the actor's movement.

### SUMMARY

An assembly includes at least one processor programmed with instructions to correlate a location of at least one virtual object in a virtual computer simulation space to a real world location on a stage. The processor is programmed to, using correlating the location of the virtual object in the virtual computer simulation space to the real world location on the stage, control at least one laser device to project, onto the real world location on the stage, a visible geometric shape to indicate the virtual object.

In example embodiments the visible geometric shape can be a primitive shape such as a rectangle or square that is not configured as the virtual object.

If desired, the processor may be configured to control the laser device to project at least one warning marker onto the stage responsive to a person approaching or within the real world location on the stage that is correlated to the location of the virtual object in the virtual computer simulation.

In some implementations the laser device can include at least one laser emitter and at least one movable mirror configured to reflect light from the laser emitter at demanded angles.

If desired, the sound stage can include a motion capture (MoCap) sound stage with plural infrared (IR) reflectors mounted on at least one surface of the stage. Plural IR reflectors also may be configured to be attached to at least one actor on the stage. At least one IR detector can be configured to detect reflections of IR light from the IR reflectors but not to detect light from the laser device. The IR detector is for providing signals representing locations on the stage to at least one processor.

In some embodiments the processor may be programmed with instructions to correlate a coordinate system of the laser device to a coordinate system of the stage. The processor can be programmed with instructions to correlate the coordinate system of the laser device to a coordinate system of the virtual computer simulation space.

In another aspect, a method includes identifying at least one virtual object having an emulated location on a real world stage, and projecting, onto the emulated location on the real world stage, a visible geometric shape to indicate the virtual object using at least one laser device.

In still another aspect, an apparatus includes at least one laser device and at least one processor programmed to control the laser device to project onto a stage a visible representation of at least one virtual object consistent with an emulated location of the virtual object in the real world.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 illustrates multiple visible laser primitives on the floor of a sound set or stage;

FIG. 3 illustrates a laser device mounted on a rail above the sound stage;

FIG. 4 illustrates three dimensional (3D) laser primitives on a real world sound stage;

FIG. 5 illustrates a schematic view of a virtual object in a virtual computer simulation space to be mapped to a schematic real world location on a sound stage, along with a laser device to project, onto the real world location on the sound stage, a visible geometric shape to indicate the virtual object;

FIG. 6 illustrates an example laser device;

FIG. 7 illustrates example logic in example flow chart format for correlating coordinate systems between the real world and virtual space;

FIG. 8 illustrates a laser device projecting a shape onto the floor of a real world set or sound stage;

FIG. 9 illustrates a laser device projecting a proximity warning shape into the real world set or sound stage;

FIG. 10 illustrates example logic in example flow chart format consistent with present principles;

FIG. 11 illustrates real world and virtual world coordinate systems superimposed on each other;

FIG. 12 illustrates example logic in example flow chart format related to the concepts illustrated in FIG. 11; and

FIGS. 13-15 illustrate the real world with a mocap system and tracking a virtual object on-screen, with the laser projecting a shape/space into the location in the real world the virtual object is emulated to occupy using physical dimensions of the virtual object.

### DETAILED DESCRIPTION

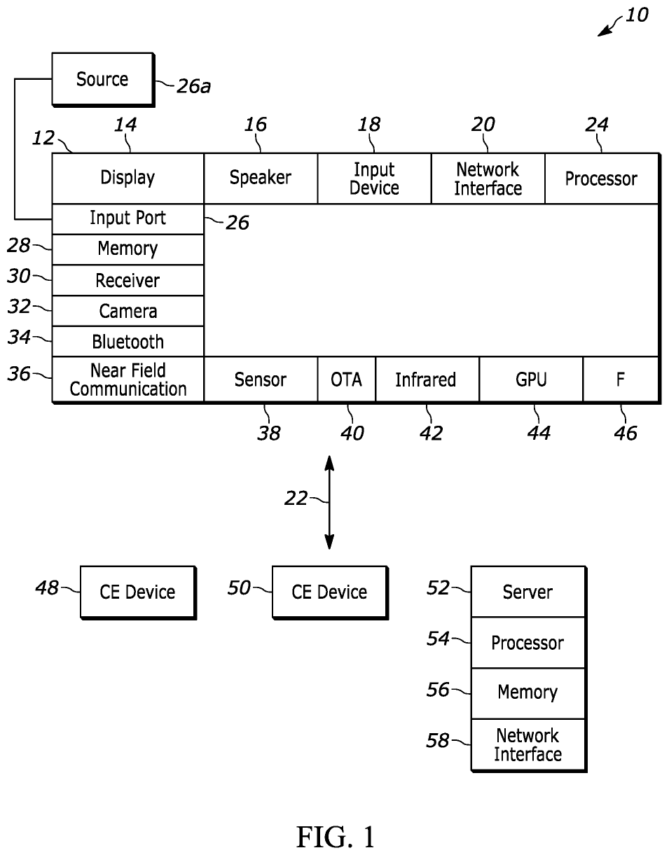

Now referring to FIG. 1, this disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be a general-purpose single-or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C #or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example system 10 is shown, which may include one or more of the example devices mentioned above and described further below in accordance with present principles. Note that computerized devices described in the figures herein may include some or all of the components set forth for various devices in FIG. 1.

The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for communication over at least one network 22 such as the Internet, other wide area network (WAN), a local area network (LAN), a personal area network (PAN), etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid state storage, and at least one network interface 58 that, under control of the server processor 54, allows for communication with the other devices of FIG. 1 over the network 22, and indeed may facilitate communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or, the server 52 may be implemented by a game console or other computer in the same room as the other devices shown in FIG. 1 or nearby.

The devices described below may incorporate some or all of the elements described above.

“Geographically distant” refers to locations that are beyond sight and sound of each other, typically separated from each other by a mile or more.

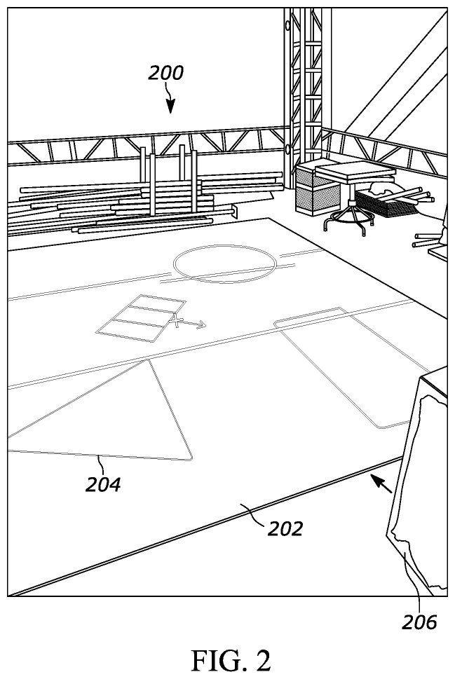

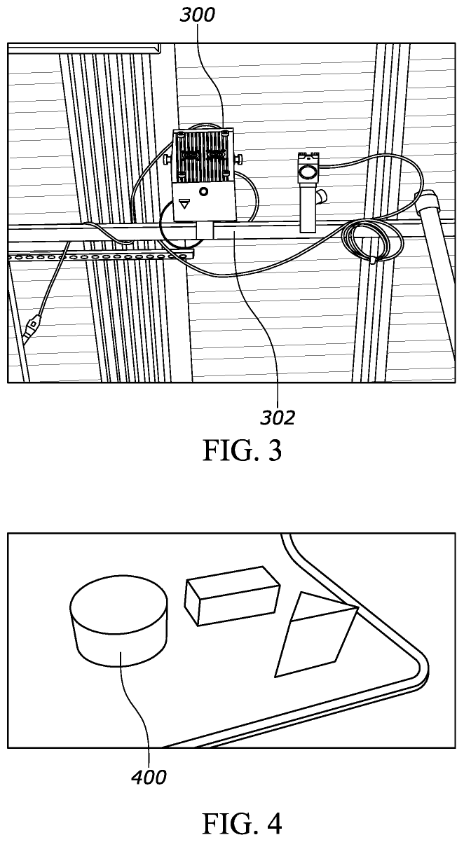

FIG. 2 illustrates a real world movie set or sound stage 200 on the floor 202 of which appear multiple primitives 204 projected onto the floor by a laser device 300 (FIG. 3) disposed above the floor on a beam 302. The primitives 204 may be two dimensional as shown in FIG. 2 and may include, as shown, circles, rectangles, and triangles, all of which may be projected onto the floor in their own respective color. As set forth further herein, the primitives 204 represent areas in real world space corresponding to virtual objects in a virtual world that may be used for computer-generated imagery (CGI). A stagehand can move a real world object 206 onto the primitives, guided by the primitives, so that an actor can avoid the real world objects 206 as he or she would avoid the corresponding virtual object.

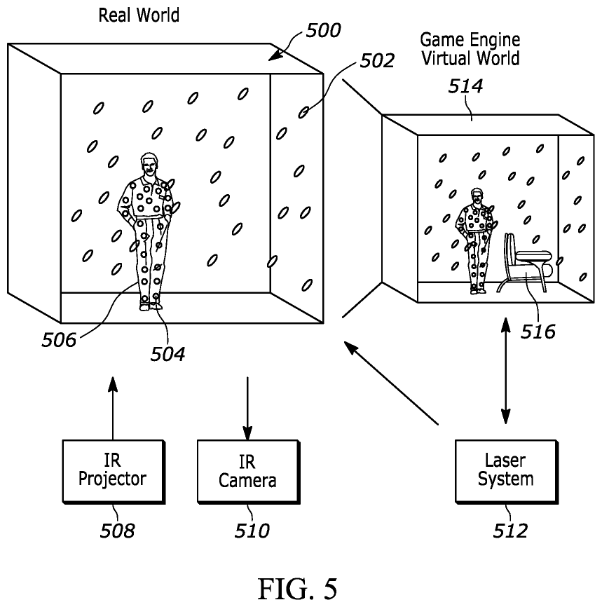

It is to be understood that in lieu of primitive shapes, the laser 300 may project more complex shapes, such as the outlines of a complex virtual world object or 3D primitive or complex shapes 400 as shown in FIG. 4. It is to be further understand that while FIG. 3 shows only a single laser, plural laser devices may be used, and each laser device may be independently movable over the set if desired.

Thus, it may be appreciated that one or more lasers are used to align a virtual environment in a game engine with a real piece of equipment on the stage using a laser to project where to put the real piece of gear.

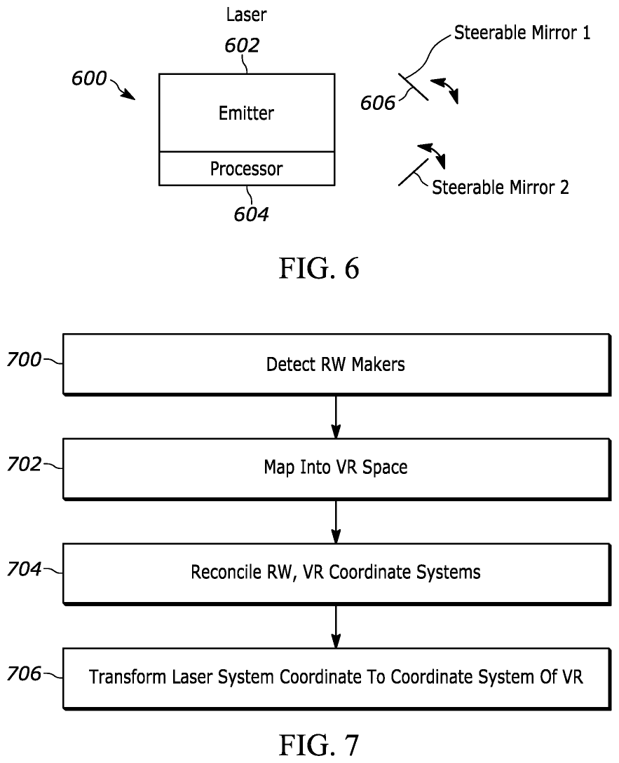

FIG. 5 illustrates a real world sound stage or movie set 500 that includes motion capture (MoCap) technology in the form of IR-reflective markers 502 spaced on the walls and floors and also MoCap reflectors 504 attached to a human actor 506. One or more IR projectors 508 may be used to project IR light into the set to be reflected by the reflectors, which reflections are detected by one or more IR cameras 510. Based on the reflections, the coordinates of the set and the location of the actor on the set are known. More specifically, the reflections from the reflectors 502 inside the set 500 together establish points of a volume that can be constructed in computer processing using the points.

The laser 300 shown in FIG. 3 as well as a laser device 512 shown in FIG. 5, on the other hand, project visible light onto the set. Advantageously, the Mocap system is not impeded by the laser device 512 because the MoCap system operates on infrared light and the laser device 512 is based on visible light.

FIG. 5 also schematically shows a virtual world 514 that may be implemented by a computer simulation such as a computer game engine. One or more virtual objects 516 such as a chair are in the virtual world 514.

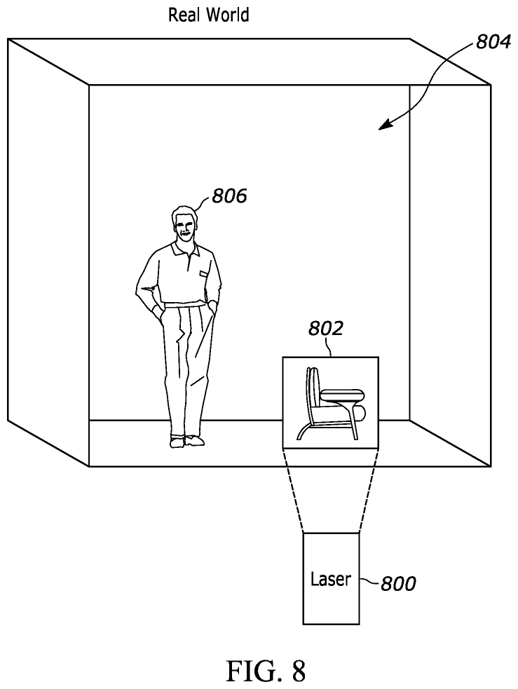

Briefly referring to FIG. 6, a laser device 600 which can implement any of the laser devices herein includes a laser emitter 602 such as a laser diode and one or more processors 604 for controlling the laser emitter. To steer the beam of the laser, the laser emitter may be movably mounted for motion under control of the processor 604 or, as shown, plural mirrors 606 may be moved under control of the processor to steer the beam as it exits the emitter 602.

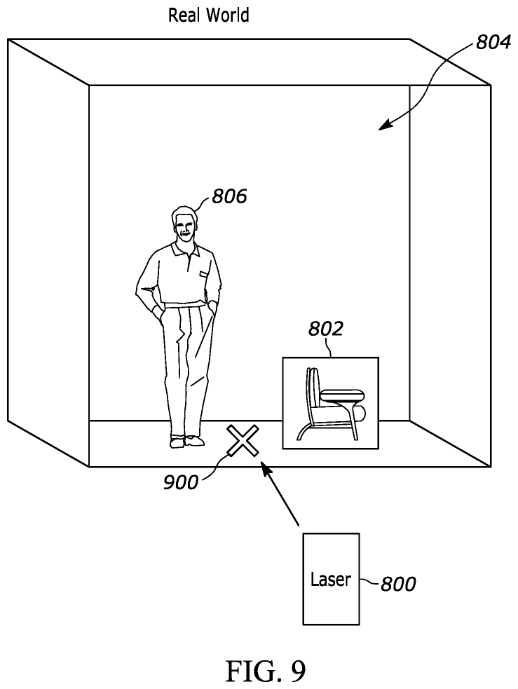

FIG. 7 illustrates further details. Commencing at block 700, one or more processors such as any processors herein receive signals indicating detection of the real world MoCap markers (e.g., the reflectors 502, 504 shown in FIG. 5) indicating location of the real world set and the location of the actor therein. Moving to block 702, the real world coordinates may be mapped into a virtual space of a computer simulation, with the real world and virtual coordinate systems being reconciled at block 704. Details below provide an example of how this can be done. Moving to block 706, the laser device coordinate system is aligned or transformed to accord with the real world and virtual coordinate systems. In this way, the laser device “knows” where to project the images onto the sound stage.

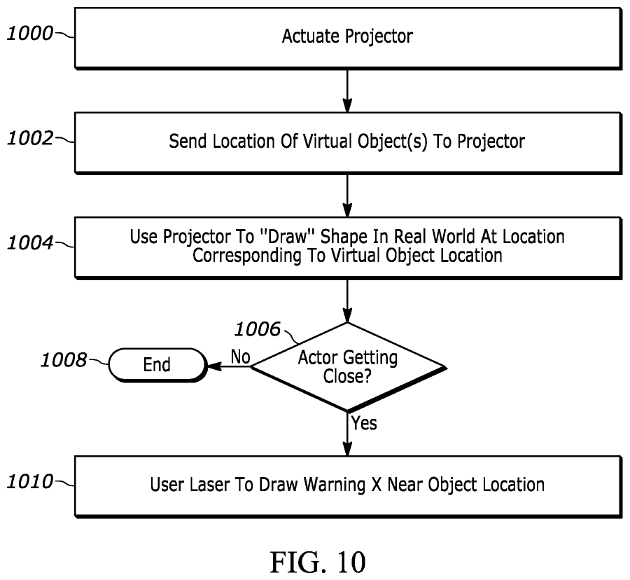

FIG. 8 illustrates further. An aligned laser device 800 is shown projecting a an image 802 of a primitive shape into a sound stage or set 804 in which an actor 806 is located. For purposes of disclosure, assume the real world location at which the image 802 is projected corresponds to the virtual world location of the virtual object 516 (chair) shown in FIG. 5. Thus, since it is known from the MoCap system where the actor 806 is relative to the “Virtual Set” the laser 800 can project shapes into the set indicating locations where virtual objects are emulated to be in the real world.

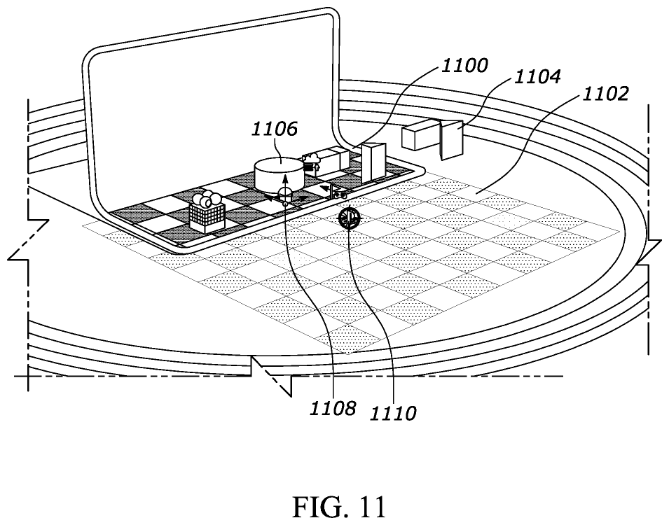

Furthermore, as shown in FIG. 9 by knowing the actor's location the laser device 800 may project a warning sign 900 such as an “X” near the image 802 to indicate someone has breached or is about to breach the space outlined. and indicate to the operator that the actor is “within” or nearly within a virtual object. This could happen both virtually in the game engine and on-set with the laser. In this way, the actor 806 and/or director, in visually discerning the warning sign 900, can take steps to avoid entering the area that is supposed to be already occupied by the virtual object.

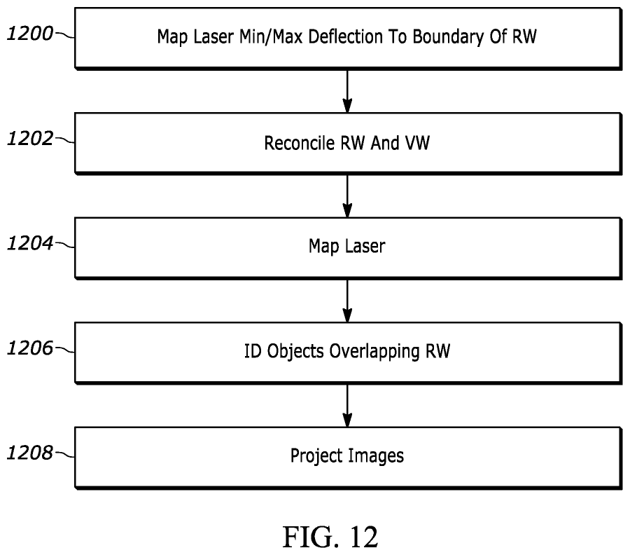

FIG. 10 illustrates this in flow chart form as may be executed by any processor herein. A visible laser device is actuated at block 1000. The location of one or more virtual objects is provided to the laser at block 1002, and in turn the laser and its mirrors are controlled at block 1004 to project visible shapes into the real-world sound stage or set at locations corresponding to the virtual locations of the virtual objects.

If it is determined, based on MoCap data, that an actor has penetrated or is about to penetrate the space that is supposed to be occupied by a virtual object at state 1006, the logic can move to state 1010 to use the laser to project a warning such as an “X” near or on the location of the virtual object. The logic may otherwise end at state 1008.

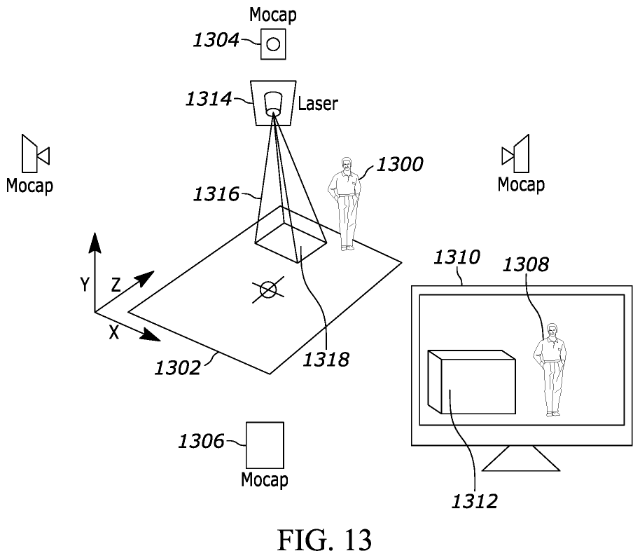

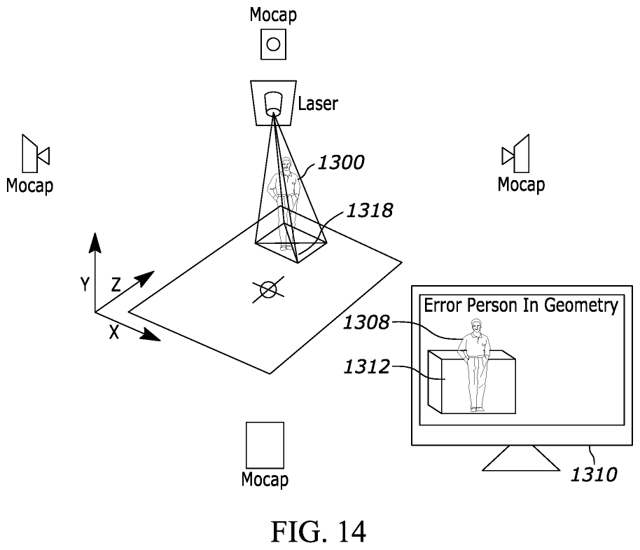

FIGS. 11 and 12 illustrate an example technique for aligning the real and virtual worlds in a manner that the laser can know where to project the visible images onto the sound stage or movie set. The Mocap stage (real world) is indicated by the top checkerboard 1100 in FIG. 11, which has been overlaid onto the virtual world indicated by the larger, bottom checkerboard 1102. The size and shape of the real world 1100 is obtained from the detected reflections from the MoCap reflectors 502 shown in FIG. 5, it being understood that other means of indicating the real world coordinates may be used, e.g., using global positioning satellite (GPS) receivers positioned around the real world set or stage, or by manually entering real world coordinates of the stage or set into the game engine. Note that the location of the MoCap “real world” may need to be calibrated with each use.

As shown in FIG. 11, one or more virtual objects 1104 are located in the virtual world outside the overlap with the real-world coordinates while one or more virtual objects 1106 are located in the virtual world within the overlap with the real world coordinates. Note that in FIG. 11, the virtual world (game engine) coordinate system origin (0,0,0) is shown at 1108 whereas the origin (0,0,0) of the real world sound stage (such as a MoCap stage) is illustrated at 1110. Since the locations of both coordinate system origins is known, locations in the virtual world can be directly mapped to locations in the real world using a transform from the virtual origin to the real world origin.

With the environment of FIG. 11 in mind, at block 1200 in FIG. 12 the laser device(s) are configured so that their min/max deflection in the X and Y dimensions is “mapped” to the same area and dimensions of the real world sound stage or set, e.g., as indicted by MoCap. Then at block 1202 the real world and virtual world coordinate systems are reconciled. In the example shown, a computer presentation appearing as in FIG. 11 is used in which the real world checkerboard 1100 is dragged using, e.g., a point and click device, relative to the virtual world checkerboard 1102 until a desired real world-to-virtual world alignment is obtained. Proceeding to block 1204 the laser is then be “mapped” to cover the same real world area. Moving to block 1206, the virtual objects 1106 within the overlap region of the real world and virtual world are identified along with their locations. Those locations are used by the laser at block 1208 to project the visible images onto the sound stage as described herein. However, virtual objects 1104 outside the overlap region are not considered for image drawing in the real world.

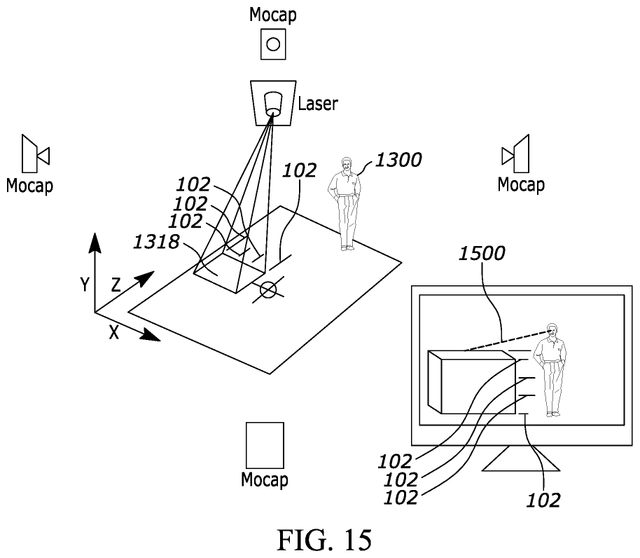

FIGS. 13-15 illustrate still further. An actor 1300 on a real-world stage 1302 is imaged by one or more MoCap cameras 1304, e.g., by detecting reflections of IR light from a source 1306 of IR light onto MoCap reflectors on the actor. An image 1308 can be presented of the actor on a remote display 1310, along with images of one or more virtual objects 1312. One or more lasers 1314 can project visible light 1316 onto the real world stage 1302 at a location 1318 corresponding to the size and emulated location of virtual object 1312.

FIG. 14 illustrates the situation in which the actor 1300 has encroached into the location 1318 that is supposed to be occupied by the virtual object 1312. This encroachment is reflected on the display 1310 as shown, With the image 1308 of the actor shown erroneously inside the virtual object 1312.

FIG. 15 illustrates the situation in which the actor 1300 can see (indicated by the lines 1500) the projection from the laser to ascertain where the virtual object is emulated to be in the real world, and thereby avoid encroachment into the space that is supposed to be occupied by the virtual object. One or more visible indicia 102 may be projected near the location 1318 of the virtual object to alert the actor 1300 that he or she is about to encroach into the space 1318. Thus, the application for encroachment, as well as movement, synchronizes the virtual movement of an object with its physical counterpart, drawn by the laser.

It will be appreciated that whilst present principals have been described with reference to some example embodiments, these are not intended to be limiting, and that various alternative arrangements may be used to implement the subject matter claimed herein.

What is claimed is:

1. An assembly, comprising:
at least one processor programmed with instructions to:
correlate a location of at least one virtual object in a virtual computer simulation space to a real-world location on a stage; and
using correlating the location of the virtual object in the virtual computer simulation space to the real world location on the stage, control at least one laser device to project, onto the real world location on the stage, a visible geometric shape to indicate the virtual object.

2. The assembly of claim 1, wherein the visible geometric shape is a primitive shape that is not configured as the virtual object.

3. The assembly of claim 2, wherein the primitive shape is a rectangle and/or a triangle.

4. The assembly of claim 1, wherein the processor is configured to control the laser device to project at least one warning marker onto the stage responsive to a person approaching or within the real world location on the stage correlated to the location of the virtual object in the virtual computer simulation.

5. The assembly of claim 1, wherein the laser device comprises at least one laser emitter and at least one movable mirror configured to reflect light from the laser emitter at demanded angles.

6. The assembly of claim 1, wherein the sound stage comprises a motion capture (MoCap) stage comprising plural infrared (IR) reflectors mounted on at least one surface of the stage.

7. The assembly of claim 6, comprising plural IR reflectors configured to be attached to at least one actor on the stage.

8. The assembly of claim 6, comprising at least one IR detector configured to detect reflections of IR light from the IR reflectors but not to detect light from the laser device, the IR detector for providing signals representing locations on the stage to at least one processor.

9. The assembly of claim 1, wherein the processor is programmed with instructions to correlate a coordinate system of the laser device to a coordinate system of the stage.

10. The assembly of claim 9, wherein the processor is programmed with instructions to correlate the coordinate system of the laser device to a coordinate system of the virtual computer simulation space.

11. A method, comprising:
identifying at least one virtual object having an emulated location on a real-world stage; and
projecting, onto the emulated location on the real world stage, a visible geometric shape to indicate the virtual object using at least one laser device.

12. The method of claim 11, wherein the visible geometric shape is a primitive shape that is not configured as the virtual object.

13. The method of claim 12, wherein the primitive shape is a rectangle.

14. The method of claim 12, wherein the primitive shape is a triangle.

15. The method of claim 11, wherein the laser device comprises at least one laser emitter and at least one movable mirror configured to reflect light from the laser emitter at demanded angles.

16. The method of claim 11, wherein the stage comprises a motion capture (MoCap) stage comprising plural infrared (IR) reflectors mounted on at least one surface of the stage.

17. The method of claim 16, wherein plural IR reflectors are configured to be attached to at least one actor on the stage.

18. The method of claim 16, wherein at least one IR detector is configured to detect reflections of IR light from the IR reflectors but not to detect light from the laser device, the IR detector providing signals representing locations on the stage.

19. The method of claim 11, comprising correlating a coordinate system of the laser device to a coordinate system of the stage.

20. An apparatus comprising:
at least one laser device; and
at least one processor programmed to control the laser device to project onto a stage a visible representation of at least one virtual object consistent with an emulated location of the virtual object in the real world.
